(19) United States
(12) Patent Application Publication
(10) Pub. No.: US 2006/0093182 A1
(43) Pub. Date: May 4, 2006

(54) Speaker

(75) Inventor: Toshifumi Kato, Tendo (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/240,360

(22) Filed: Oct. 3, 2005

(30) Foreign Application Priority Data
Oct. 4, 2004 (JP) 2004-291747

(51) Int. Cl. H04R 9/06

(52) U.S. Cl. 381/433

(57) ABSTRACT

A speaker is provided, by which a voice coil bobbin can be prevented from coming in contact with a yoke, thereby preventing the voice coil bobbin from being deformed. The speaker includes a diaphragm unit, magnetic circuit unit, case and restriction member. The diaphragm unit includes a diaphragm, damper and voice coil bobbin to which a voice coil is attached. The magnetic circuit unit includes a yoke that attaches a magnet thereto and faces to an end of the voice coil bobbin along an axis. The case is arranged between the damper and magnet facing to the damper along the axis. The restriction member protrudes from an inner edge of the casing toward the damper. The restriction member comes in contact with the damper, thereby preventing the end of the voice coil bobbin from coming in contact with the yoke, even if the end approaches the yoke.

### BACKGROUND OF THE INVENTION

(1) Field of the Invention

The present invention relates to a speaker.

(2) Description of the Related Art

A conventional speaker used so far includes a diaphragm unit, magnetic circuit unit for generating a sound by vibrating the diaphragm unit, and damper. The diaphragm unit includes: a voice coil for vibrating a diaphragm in cooperation with the magnetic circuit unit arranged within a magnetic gap (explained later on) of the magnetic circuit unit; the diaphragm vibrating with the voice coil to generate a sound; and a voice coil bobbin for attaching the voice coil thereto and supporting the diaphragm.

The magnetic circuit unit consisting of magnetic material formed in a ring-shape includes: a yoke plate as a facing member facing to the damper in a vibration direction of the diaphragm; a magnet attached to the yoke plate; and a yoke as a magnet attaching member for forming the magnetic gap for generating a magnetic force for driving (i.e. vibrating) the diaphragm between the yoke plate and the yoke, wherein the yoke consists of magnetic material and is attached to the magnet.

The damper is arranged between the diaphragm and the magnetic circuit unit. The damper is attached to the voice coil bobbin. The damper allows the voice coil bobbin to vibrate with the diaphragm and gradually attenuates the vibration of the diaphragm and voice coil bobbin.

When the voice coil is supplied with a voice current so that the voice coil bobbin vibrates the diaphragm in response to the voice current, the speaker constructed as described above generates a sound according to the voice current from the diaphragm, that is, from the diaphragm unit.

In the conventional speaker as described above, when the voice coil bobbin comes in contact with the yoke, the voice coil bobbin is deformed. When the voice coil bobbin is deformed, the voice coil bobbin abuts against the yoke plate or yoke, causing generation of an abnormal sound. Further, in a speaker in which a brocaded thread wire is directly soldered to the voice coil bobbin, when the soldered portion is located at the bottom of the damper, the soldered portion might abut against the magnetic circuit upon inputting of an excess input, causing damage to the soldered portion.

Therefore, in the conventional speaker as described above, a distance between the voice coil bobbin and the yoke in the vibration direction of the diaphragm is made larger than a distance between the damper and the yoke plate in the vibration direction of the diaphragm. Thereby, when the diaphragm approaches the magnetic circuit unit, the diaphragm is made come in contact with the yoke plate before the voice coil bobbin comes in contact with the yoke, so that the voice coil bobbin is prevented from coming in contact with the yoke. Thus, in the conventional speaker, the voice coil bobbin is prevented from being deformed.

However, if the distance between the voice coil bobbin and the yoke in the vibration direction of the diaphragm is made larger than the distance between the damper and the yoke plate in the vibration direction of the diaphragm as described above, a projection length toward the back side of the speaker viewed from the diaphragm of the magnetic circuit unit becomes large, causing a large size of the speaker itself.

Accordingly, for the sake of down-sizing of a speaker, the distance between the voice coil bobbin and the yoke in the vibration direction of the diaphragm cannot be made larger than the distance between the damper and the yoke plate in the vibration direction of the diaphragm. Then, if such a measure is not used, the voice coil bobbin comes in contact with the yoke, resulting in that the voice coil bobbin is undesirably deformed.

### SUMMARY OF THE INVENTION

It is therefore an objective of the present invention to solve the above problem and to provide a speaker, by which even if the distance between the voice coil bobbin and the yoke (i.e. magnet attaching member) in the vibration direction of the diaphragm cannot be made larger than the distance between the damper and the yoke plate (i.e. facing member) in the vibration direction of the diaphragm, the voice coil bobbin can be prevented from coming in contact with the yoke, thereby preventing the voice coil bobbin from being deformed.

In order to attain the above objective, the present invention is to provide a speaker including:
a diaphragm unit including a diaphragm that vibrates to generate a sound and a damper that allows the diaphragm to vibrate and gradually attenuates a vibration of the diaphragm;
a magnetic circuit unit that includes a magnet and vibrates the diaphragm to generate a sound; and
a facing member that is arranged between the damper and the magnet and faces to the damper in a vibration direction of the diaphragm,
   wherein the diaphragm unit includes a voice coil bobbin to which a voice coil for vibrating the diaphragm in cooperation with the magnetic circuit unit is attached,
   wherein the magnetic circuit unit includes a magnet attaching member that attaches the magnet thereto and faces to an end of the voice coil bobbin, to which the voice coil is attached, in the vibration direction of the diaphragm,
   wherein a distance between the damper and the facing member in the vibration direction of the diaphragm is larger than a distance between the end of the voice coil bobbin and the magnet attaching member in the vibration direction of the diaphragm, and
   wherein the speaker further includes a restriction member that is arranged between the damper and the magnet and situated nearer to the diaphragm than the facing member, and even if the end of the voice coil bobbin approaches the magnet attaching member, the restriction member comes in contact with the damper so that the end of the voice coil bobbin is prevented from coming in contact with the magnet attaching member.

### BRIEF DESCRIPTION OF THE DRAWINGS

FIG. 1 is a cross-sectional view illustrating a speaker according to a preferred embodiment of the present invention; and

FIG. 2 is a cross-sectional view illustrating a state when an end of a voice coil bobbin of the speaker shown in FIG. 1 approaches a bottom plate of a yoke.

### DESCRIPTION OF THE PREFERRED EMBODIMENTS

In the following, a speaker according to a preferred embodiment of the present invention will be explained. The speaker includes a restriction member which is arranged between the damper and magnet. The restriction member is situated nearer to the diaphragm than the facing member is. Even if a distance between the diaphragm and the facing member in the vibration direction of the diaphragm is larger than a distance between the end of the voice coil bobbin and the magnet attaching member in the vibration direction of the diaphragm, when the end of the voice coil bobbin approaches the magnet attaching member, the restriction member comes in contact with the damper, so that the end of the voice coil bobbin is prevented from coming in contact with the magnet attaching member, thereby preventing the voice coil bobbin from being deformed.

In the speaker, a distance between the restriction member and the damper in the vibration direction of the diaphragm is smaller than the distance between the end of the voice coil bobbin and the magnet attaching member in the vibration direction of the diaphragm.

Further, in the speaker, the distance between the restriction member and the damper in the vibration direction of the diaphragm is smaller than a distance between the connection part and the magnetic circuit unit in the vibration direction of the diaphragm.

### EXAMPLES

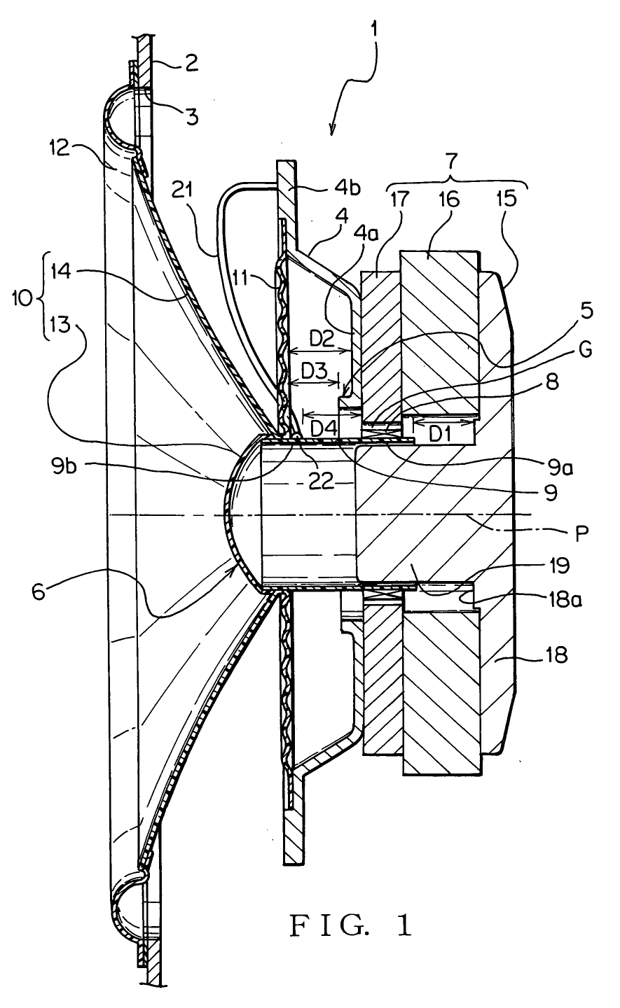

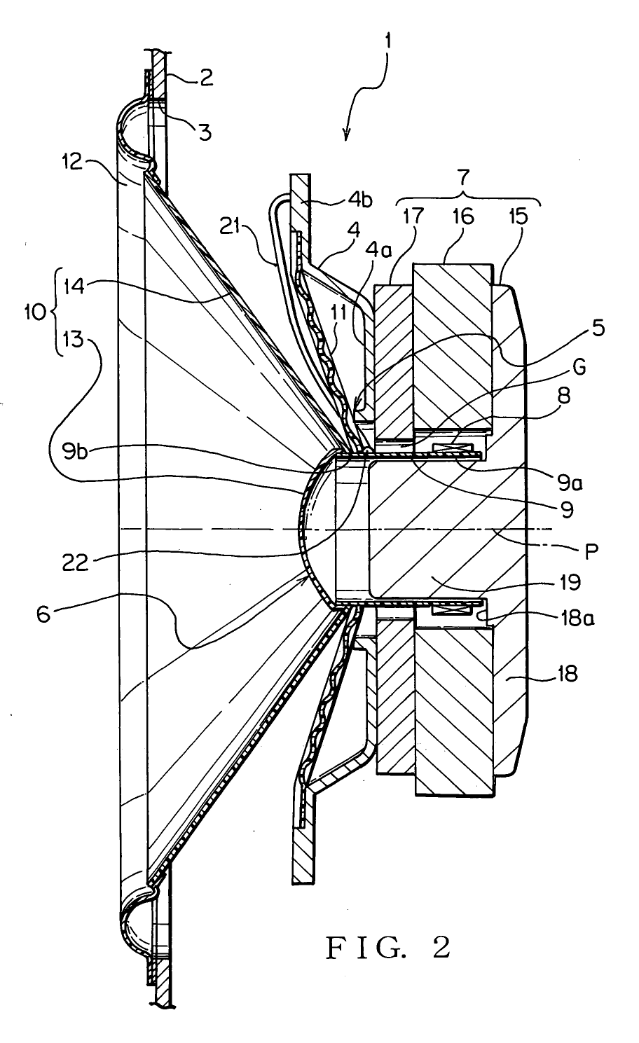

In the following, a preferred embodiment of the present invention will be explained with reference to FIGS. 1 and 2. A speaker 1 according to the preferred embodiment of the present invention is attached to a frame 2 of a box or the like placed on a floor or the like and generates a sound. The frame 2 is provided with a hole 3 for exposing a diaphragm 10 and so on of the speaker 1.

As shown in FIG. 1, the speaker 1 includes a diaphragm unit 6, magnetic circuit unit 7 for vibrating the diaphragm unit 6 so as to allow the diaphragm unit 6 to generate a sound, case 4, and restriction member 5. The case 4 may be formed in one piece with the frame 2. (However, instead, the case 4 may be formed separately from the frame 2.)

The diaphragm unit 6 includes a voice coil 8, voice coil bobbin 9, diaphragm 10, damper 11, edge 12, brocaded thread wire 21 and so on. The voice coil 8 is arranged coaxially with both of a yoke 15 (explained later on) and yoke plate 17 (explained later on) of the magnetic circuit unit 7 within a magnetic gap G (explained later on) of the magnetic circuit unit 7. A voice current is supplied to the voice coil 8 through the brocaded thread wire 21. When a voice current is supplied to the voice coil 8, the voice coil 8 vibrates a diaphragm 10 (i.e. vibrates the diaphragm unit 6) along an axis P in cooperation with the magnetic circuit unit 7.

The voice coil bobbin 9 is formed in a cylindrical shape. The voice coil bobbin 9 is arranged coaxially with the yoke 15, yoke plate 17 and voice coil 8. An end 9a of the voice coil bobbin 9 in a direction of the axis P is inserted in the magnetic gap G. The voice coil 8 is attached to an outer periphery of the end 9a. The end 9a is an end to which the voice coil bobbin 9 is attached.

The voice coil bobbin 9 is supported by the yoke 15 movably along the axis P (shown with an alternate long and short dash line in FIG. 2) of the yoke 15. The axis P corresponds to a vibration direction of the diaphragm 10 (i.e. a vibration direction of the diaphragm unit 6).

The diaphragm 10 includes: a thin plate-shaped center cap 13 having an arc-shape in section and a disc-shape in plan view; and a thin plate-shaped cone 14 having a circular truncated cone shape in side view and an annular shape in plan view. The cone 14 is arranged axially with the center cap 13 (i.e. arranged axially with the yoke 15). An inner edge lo of the cone 14 is attached to an opposite end 9b of the voice coil bobbin 9. An outer edge of the center cap 13 is attached to the cone 14, so that the center cap 13 closes the voice coil bobbin 9.

The damper 11 is formed in a thin plate-shape having an annular shape in plan view. An inner edge of the damper 11 is attached to the opposite end 9b of the voice coil bobbin 9. An outer edge of the damper 11 is attached to an inner surface of a case 4 (explained later on). The damper 11 allows the voice coil bobbin 9 to vibrate along the axis P and gradually attenuates the vibration of the voice coil bobbin 9. That is, the damper 11 allows the diaphragm 10 to vibrate along the axis P and gradually attenuates the vibration of the diaphragm 10.

The edge 12 is formed in a thin plate-shape having an annular shape in plan view. An inner edge of edge 12 is attached to an outer edge of the cone 14. An outer edge of the edge 12 is attached to an inner line part of the hole 3 of the frame 2. The edge 12 allows the voice coil bobbin 9 to vibrate along the axis P and gradually attenuates the vibration of the voice coil bobbin 9. That is, edge 12 allows the diaphragm 10 to vibrate along the axis P and gradually attenuates the vibration of the diaphragm 10.

An end of the brocaded thread wire 21 is connected to the voice coil 8 on an outer peripheral surface of the opposite end 9b of the voice coil bobbin 9, while an opposite end of the brocaded thread wire 21 is connected to a terminal (not shown in the figure) or the like on the case 4. The brocaded thread wire 21 is connected to the voice coil 8 and a terminal (not shown in the figure) by brazing with a solder or the like. Therefore, on an outer peripheral surface of the opposite end 9b of the voice coil bobbin 9, there is provided a connection part 22 consisting of the solder or the like for connecting the voice coil 8 and the brocaded thread wire 21.

The magnetic circuit unit 7 includes the yoke 15 consisting of magnetic material (i.e. paramagnetic material or ferromagnetic material), magnet 16, and a yoke plate 17 consisting of magnetic material (i.e. paramagnetic material or ferromagnetic material). The yoke 15 corresponds to the magnet attaching member. The yoke 15 integrally includes a disc-shaped bottom plate 18 and a cylindrical center pole 19, which stands up from the center of the bottom plate 18 and is arranged coaxial with the bottom plate 18.

An outer diameter of the bottom plate 18 is larger than that of the center pole 19. The yoke 15 is arranged so that an end of the center pole 19 on the side situated away from the bottom plate 18 enters the inside of the end 9a of the voice coil bobbin 9. A portion 18a of the bottom plate 18 located near to the center pole 19 faces the end 9a of the voice coil bobbin 9 along the axis P.

The magnet 16 is formed in an annular shape. The magnet 16 may be a permanent magnet or a magnet that is magnetized with a direct-current power supply. On a condition that the center pole 19 of the yoke 15, the end 9a of the voice coil bobbin 9 and voice coil 8 enter the inside of the magnet 16, the magnet 16 is piled up on the bottom plate 18 of the yoke 15 so that the magnet 16 is attached to the yoke 15.

The yoke plate 17 is formed in an annular shape. On a condition that the center pole 19 of the yoke 15 enters the inside of the yoke plate 17, the yoke plate 17 is piled up on the magnet 16. The yoke plate 17, magnet 16 and yoke 15 are fixed to each other. The yoke plate 17, magnet 16 and yoke 15 are arranged coaxially with each other. There is an interval between an outer peripheral surface of the center pole 19 and an inner peripheral surface of the yoke plate 17.

According to the construction described above, the magnetic circuit unit 7 is constructed in a so-called outer magnet type. The magnetic circuit unit 7 has a magnetic gap G between the outer peripheral surface of the center pole 19 and the inner peripheral surface of the yoke plate 17, wherein the gap G is provided to generate magnetic force for driving (vibrating) the diaphragm 10 in cooperation with the voice coil 8.

The case 4 is formed in an annular shape. The case 4 is arranged coaxially with both of the diaphragm unit 6 and the magnetic circuit unit 7. An inner edge 4a of the case 4 is piled up on the yoke plate 17 so that the case 4 is attached to the yoke plate 17. The inner edge 4a of the case 4 corresponds to the facing member. An outer edge of the damper 11 is attached to an outer edge 4b of the case 4.

Therefore, the inner edge 4a of the case 4 is arranged between the damper 11 and the magnet 16. The inner edge 4a of the case 4 faces the damper 11 along the axis P. As described above, the case 4 is normally formed integrally with the frame 2 and therefore, it can be said that the frame 2 is provided with the inner edge 4a and the outer edge 4b.

The restriction member 5 is formed in an annular shape on the inner edge 4a of the case 4. The restriction member 5 is arranged coaxially with the case 4 and formed integrally (i.e. formed in one piece) with the case 4. The restriction member 5 protrudes from the inner edge 4a of the case 4 toward the damper 11. Therefore, the restriction member 5 is arranged between the damper 11 and the magnet 16. The restriction member 5 is arranged nearer to the diaphragm 10 than the inner edge 4a of the case 4 is. If the case 4 is formed integrally with the frame 2, it can be said that the frame 2 is provided with the restriction member 5.

In the speaker 1 constructed as described above, a distance D2 between the damper 11 and the inner edge 4a of the case 4 in the direction of the axis P is larger than a distance D1 between the end 9a of the voice coil bobbin 9 and the portion 18a of the bottom plate 18 of the yoke 15 in the direction of the axis P. Further, in the speaker 1 constructed as described above, a distance D3 between the damper 11 and the restriction member 5 in the direction of the axis P is smaller than the distance D1 between the end 9a of the voice coil bobbin 9 and the portion 18a of the bottom plate 18 of the yoke 15 in the direction of the axis P. Further, the distance D3 between the damper 11 and the restriction member 5 in the direction of the axis P is smaller than a distance D4 between the connection part 22 and the yoke plate 17 of the magnetic circuit unit 7 in the direction of the axis P.

In the speaker 1 constructed as described above, a voice current is supplied to the voice coil 8, then the voice coil 8 held in the magnetic gap G vibrates along the axis P in response to the voice current. Then, the voice coil bobbin 9 that supports the voice coil 8 vibrates along the axis P together with the center cap 13 and the cone 14 of the diaphragm 10, so that the center cap 13 and the cone 14 generate a sound according to the voice current. Thus, the magnetic circuit unit 7 vibrates the diaphragm 10, that is, vibrates the diaphragm unit 6 so as to generate a sound.

Further, in the speaker 1 constructed as described above, even if an excess voice current is supplied to the voice coil 8 so that the end 9a of the voice coil bobbin 9 approaches the bottom plate 18 of the yoke 15, the damper 11 comes in contact with the restriction member 5 as shown in FIG. 2 because the distance D3 is smaller than the distance D1. That is, the restriction member 5 comes in contact with the damper 11, thereby preventing the end 9a of the voice coil bobbin 9 from coming in contact with the bottom plate 18 of the yoke 15.

Further, even if the end 9a of the voice coil bobbin 9 approaches the bottom plate 18 of the yoke 15, the restriction member 5 comes in contact with the damper 11 as shown in FIG. 2 because the distance D3 is smaller than the distance D4, thereby preventing the connection part 22 from coming in contact with the yoke plate 17, that is, preventing the connection part 22 from coming in contact with the magnetic circuit unit 7.

In the EXAMPLES described above, the restriction member 5 is arranged between the damper 11 and the magnet 16 and situated nearer to the diaphragm 10 than the inner edge 4a of the case 4. Even if the distance D2 is larger than the distance D1, when the end 9a of the voice coil bobbin 9 approaches the yoke 15, the restriction member 5 comes in contact with the damper 11, thereby preventing the end 9a from coming in contact with the bottom plate 18 of the yoke 15. Therefore, the voice coil bobbin 9 can be prevented from being deformed.

Further, since the distance D3 is smaller than the distance D1, the restriction member 5 prevents the end 9a of the voice coil bobbin 9 from coming in contact with the bottom plate 18 of the yoke 15. Therefore, the voice coil bobbin 9 can be prevented from being deformed.

Furthermore, since the distance D3 is smaller than the distance D4, the connection part 22 can be prevented from coming in contact with the magnetic circuit unit 7, thereby preventing the connection part 22 from being damaged and preventing a short circuit between the brocaded thread wire 21 and the magnetic circuit unit 7 from occurring.

In the EXAMPLES described above, the speaker 1 is a so-called outer magnet type. However, instead, the speaker 1 may be a so-called inner magnet type. Further, in the EXAMPLES described above, the restriction member 5 is formed in one piece with the case 4. However, instead, the restriction member 5 may be formed separately from the case 4 or the yoke plate 17. The restriction member 5 may be formed on the yoke plate 17 and in this case, the yoke plate 17 corresponds to the facing member.

According to the EXAMPLES described above, the following speaker 1 can be attained.

(Additional Remark 1)

A speaker 1 including:
a diaphragm unit 6 including a diaphragm 10 that vibrates to generate a sound and a damper 11 that allows the diaphragm 10 to vibrate and gradually attenuates a vibration of the diaphragm 10;
a magnetic circuit unit 7 that includes a magnet 16 and vibrates the diaphragm 10 to generate a sound; and
an inner edge 4a of a case 4 that is arranged between the damper 11 and the magnet 16 and faces to the damper 11 in a vibration direction P of the diaphragm 10 (the inner edge 4a being formed on a frame 2 if the case 4 being formed in one piece with the frame 2),
   wherein the diaphragm unit 6 includes a voice coil bobbin 9 to which a voice coil 8 for vibrating the diaphragm 10 in cooperation with the magnetic circuit unit 7 is attached,
   wherein the magnetic circuit unit 7 includes a yoke 15 that attaches the magnet 16 thereto and faces to an end 9a of the voice coil bobbin 9, to which the voice coil 8 is attached, along an axis P,
   wherein a distance D2 between the damper 11 and the inner edge 4a of the case 4 in the direction of the axis P is larger than a distance D1 between the end 9a of the voice coil bobbin 9 and the yoke 15 in the direction of the axis P, and
   wherein the speaker 1 further includes a restriction member 5 that is arranged between the damper 11 and the magnet 16 and situated nearer to the diaphragm 10 than the inner edge 4a of the case 4, and even if the end 9a of the voice coil bobbin 9 approaches the yoke 15, the restriction member 5 comes in contact with the damper 11 so that the end 9a of the voice coil bobbin 9 is prevented from coming in contact with the yoke 15 (the restriction member 5 being formed on the frame 2 if the case 4 being formed in one piece with the frame 2).
   (Additional Remark 2)

The speaker 1 according to Additional Remark 1, wherein a distance D3 between the restriction member 5 and the damper 11 in the direction of the axis P is smaller than the distance D1 between the end 9a of the voice coil bobbin 9 and the yoke 15 in the direction of the axis P.

(Additional Remark 3)

The speaker 1 according to Additional Remark 1 or 2, further including a brocaded thread wire 21 that is connected to the voice coil 8 and supplies a voice current to the voice coil 8, wherein a connection part 22 of the voice coil 8 and the brocaded thread wire 21 is formed on an outer peripheral surface of the voice coil bobbin 9 between the damper 11 and the magnet 16, wherein the distance D3 between the restriction member 5 and the damper 11 in the direction of the axis P is smaller than a distance D4 between the connection part 22 and the magnetic circuit unit 7 in the direction of the axis P.

The aforementioned preferred embodiments are described to aid in understanding the present invention and variations may be made by one skilled in the art without departing from the spirit and scope of the present invention.

Incidentally, the contents of Japanese Patent Application No. 2004-291747 are hereby incorporated by reference.

What is claimed is:

1. A speaker comprising:
a diaphragm unit including a diaphragm that vibrates to generate a sound and a damper that allows the diaphragm to vibrate and gradually attenuates a vibration of the diaphragm;
a magnetic circuit unit that includes a magnet and vibrates the diaphragm to generate a sound; and
a facing member that is arranged between the damper and the magnet and faces to the damper in a vibration direction of the diaphragm,
wherein the diaphragm unit includes a voice coil bobbin to which a voice coil for vibrating the diaphragm in cooperation with the magnetic circuit unit is attached,
wherein the magnetic circuit unit includes a magnet attaching member that attaches the magnet thereto and faces to an end of the voice coil bobbin, to which the voice coil is attached, in the vibration direction of the diaphragm,
wherein a distance between the damper and the facing member in the vibration direction of the diaphragm is larger than a distance between the end of the voice coil bobbin and the magnet attaching member in the vibration direction of the diaphragm, and
wherein the speaker further comprises a restriction member arranged between the damper and the magnet and situated nearer to the diaphragm than the facing member, and even if the end of the voice coil bobbin approaches the magnet attaching member, the restriction member comes in contact with the damper so that the end of the voice coil bobbin is prevented from coming in contact with the magnet attaching member.

2. The speaker according to claim 1, wherein a distance between the restriction member and the damper in the vibration direction of the diaphragm is smaller than the distance between the end of the voice coil bobbin and the magnet attaching member in the vibration direction of the diaphragm.

3. The speaker according to claim 1 or 2, further comprising a brocaded thread wire that is connected to the voice coil and supplies a voice current to the voice coil, wherein a connection part of the voice coil and the brocaded thread wire is formed on an outer peripheral surface of the voice coil bobbin between the damper and the magnet, wherein the distance between the restriction member and the damper in the vibration direction of the diaphragm is smaller than a distance between the connection part and the magnetic circuit unit in the vibration direction of the diaphragm.
